(19) United States
(12) Patent Application Publication
(10) Pub. No.: US 2009/0089669 A1
(43) Pub. Date: Apr. 2, 2009

(54) METHOD AND APPARATUS FOR PROVIDING READABILITY CONTROL IN A PORTABLE DEVICE DISPLAY

(75) Inventor: Michael KNOWLES, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: RESEARCH IN MOTION LIMITED, Waterloo (CA)

(21) Appl. No.: 12/239,291

(22) Filed: Sep. 26, 2008

Related U.S. Application Data
(60) Provisional application No. 60/976,155, filed on Sep. 28, 2007.

(51) Int. Cl. G06F 3/14

(52) U.S. Cl. 715/273

(57) ABSTRACT

A method and system for providing readability control are described. The rendering and display of a data file on the display can be switched between a layout view and a column view. Initially, the data file is displayed on the display in one of the layout view or the column view. A portion of the displayed data file is selected by positioning a cursor over the portion and a trackball is actuated, for example, by clicking and holding the trackball for a predetermined time to display the data file in the other of the layout view or the column view within the selected portion. The selected portion is rendered on the display and centered generally in the vicinity of the cursor position when actuating the trackball.

### CROSS-REFERENCE TO RELATED APPLICATIONS

This application claims the benefit of U.S. Provisional Application No. 60/976,155, filed Sep. 28, 2007, the contents of which are incorporated herein in their entirety.

### FIELD OF THE INVENTION

The present invention relates generally to the display of information on a portable electronic device, such as a mobile communications device. In particular, the present invention relates to providing readability control in such a device.

### BACKGROUND OF THE INVENTION

People routinely use portable electronic devices to create, view, edit, receive and transmit data files. Portable electronic device displays are typically small in size and, therefore, it is a challenge to optimally display data files that are created for visualization on dedicated large-screen displays.

Most data files, such as webpages, include rendering information, such as formatting codes, tags, metadata, etc., which is used by the associated application to render the data file on a display in a desired layout format. Typically, the rendering information is optimized for displaying the data file on large-screen displays, such as a PC monitor or the like. Displaying such files on a smaller portable device display can result in loss of detail and readability. To overcome such drawbacks, webpages, and other such data files, are often displayed on a portable device display in a format that does not permit the whole file to be displayed on the screen at one time. A user can scroll the display to view hidden sections of the file. However, such navigation can be difficult or disorienting to a user, as standard visual landmarks usually available in a full layout view of the data file are not visible.

Even when a file can be fully displayed in its original layout, the small size of a portable display can make it difficult to navigate within the page. Mobile devices typically provide coarse zoom-in and zoom-out controls, but such controls often require two-handed operation, such as an ALT-click input, and do not permit a user to easily select a desired section for enlargement.

To overcome such difficulties, data files, such as webpages, are often rendered in a column, or mobile device, mode when displayed on a mobile device. Sections and components of the file are displayed sequentially in a column. Formatting and layout information is often discarded, and certain components of the data file, such as images, may not be displayed at all. To navigate within the page, the user simply scrolls vertically through the displayed information. While such a column view can result in a more readable view, the user cannot easily locate desired information, and may have to scroll down through significant amounts of unwanted information prior to arriving at the desired content.

### BRIEF DESCRIPTION OF THE DRAWINGS

Embodiments of the present invention will now be described, by way of example only, with reference to the attached Figures, wherein:

FIG. 1 is a block diagram of an embodiment of a mobile device;

FIG. 2 is a block diagram of an embodiment of a communication subsystem component of the mobile device of FIG. 1;

FIG. 3 is an exemplary block diagram of a node of a wireless network;

FIG. 4 is a block diagram illustrating components of a host system in one exemplary configuration for use with the wireless network of FIG. 3 and the mobile device of FIG. 1;

FIG. 5 shows a mobile device;

FIGS. 6(a)-6(e) show a zooming sequence;

FIGS. 7(a) and 7(b) show switching from full layout view to a column view;

FIGS. 8(a) and 8(b) show switching from a zoomed in layout view to a corresponding column view;

FIGS. 9(a) and 9(b) show switching from a column view to a corresponding layout view;

FIGS. 10(a) and 10(b) shown an escape key actuation to return to a full layout view from a column view; and

FIGS. 11(a) and 11(b) show switching from a fully zoomed in layout view to corresponding column view.

### DETAILED DESCRIPTION

Generally, there is provided a method and system for providing readability control in a portable electronic device, such as mobile wireless communications device, by switching between layout and column views of a data file, or page thereof, by single finger actuation of a trackball on the mobile device.

Embodiments of the method and system will be described in relation to a mobile wireless communication device, hereafter referred to as a mobile device. However, the description is not to be considered as limiting the scope of the described embodiments, and the method and system can be applied to any suitable portable device, such as pagers, cellular phones, cellular smart-phones, wireless organizers, personal digital assistants, computers, laptops, handheld wireless communication devices, wirelessly-enabled notebook computers and the like, having a portable device display screen and an input device, such as a touchscreen, touchpad, scroll wheel, or clickable trackball, that permits a cursor, or other visible icon, to be positioned within the display and actuated to accomplish a predetermined function related to its position within a displayed data file.

Where considered appropriate, reference numerals are repeated among the figures to indicate corresponding or analogous elements. In addition, numerous specific details are set forth in order to provide a thorough understanding of the described embodiments; however, it will be understood by those of ordinary skill in the art that the described embodiments can be practiced without these specific details. Well-known methods, procedures and components are not described in detail so as not to obscure the described embodiments.

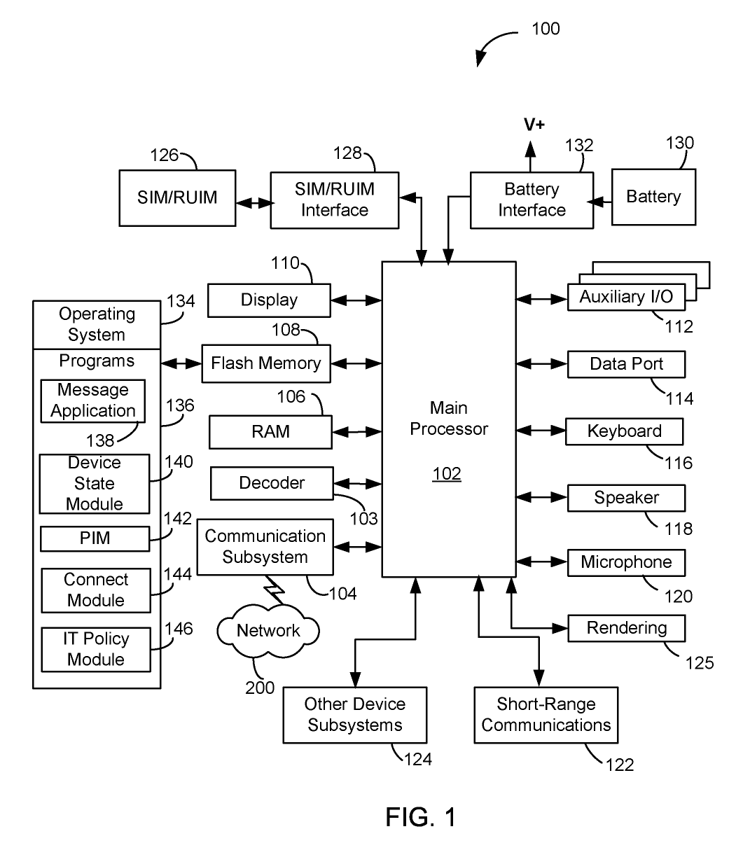

To aid in understanding the structure of the mobile device and how it communicates with other devices and host systems, reference will now be made to FIGS. 1-4, which depict an embodiment of a mobile device 100, and its associated wireless communication system. The zooming method and system can be practiced within such a system for transmission of images and data files to the mobile device 100. The mobile device 100 is a two-way communication device with advanced data communication capabilities including the capability to communicate with other mobile devices or computer systems through a network of transceiver stations. The mobile device 100 can also have voice communication capabilities. Depending on the functionality provided by the mobile device 100, it can be referred to as a data messaging device, a two-way pager, a cellular telephone with data messaging capabilities, a wireless Internet appliance, or a data communication device (with or without telephony capabilities).

FIG. 1 is a block diagram of an exemplary embodiment of a mobile device 100. The mobile device 100 includes a number of components such as a main processor 102 that controls the overall operation of the mobile device 100. Communication functions, including data and voice communications, are performed through a communication subsystem 104. Data received by the mobile device 100 can be decompressed and decrypted by decoder 103, operating according to any suitable decompression techniques, and encryption/decryption techniques according to various standards, such as Data Encryption Standard (DES), Triple DES, or Advanced Encryption Standard (AES)). Image data is typically compressed and decompressed in accordance with appropriate standards, such as JPEG, while video data is typically compressed and decompressed in accordance with appropriate standards, such as H.26× and MPEG-x series standards.

The communication subsystem 104 receives messages from and sends messages to a wireless network 200. In this exemplary embodiment of the mobile device 100, the communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with mobile device 100 is a GSM/GPRS wireless network in one exemplary implementation, other wireless networks can also be associated with the mobile device 100 in variant implementations. The different types of wireless networks that can be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems. The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, short-range communications 122 and other device subsystems 124.

Some of the subsystems of the mobile device 100 perform communication-related functions, whereas other subsystems can provide “resident” or on-device functions. By way of example, the display 110 and the keyboard 116 can be used for both communication-related functions, such as entering a text message for transmission over the network 200, and device-resident functions such as a calculator or task list.

A rendering circuit 125 is included in the device 100. When a user specifies that a data file is to be viewed on the display 110, the rendering circuit 125 analyzes and processes the data file for visualization on the display 110. Certain types of data files, specifically large format data files such as web pages, image files and spreadsheets, are rendered by the rendering circuit 125 to be displayed in either a layout view or a column view. The default view mode can be set to either. The rendering circuit 125 may be implemented as hardware, software, or as a combination of both hardware and software.

The mobile device 100 can send and receive communication signals over the wireless network 200 after required network registration or activation procedures have been completed. Network access is associated with a subscriber or user of the mobile device 100. To identify a subscriber, the mobile device 100 requires a SIM/RUIM card 126 (i.e. Subscriber Identity Module or a Removable User Identity Module) to be inserted into a SIM/RUIM interface 128 in order to communicate with a network. The SIM/RUIM card 126 is one type of a conventional “smart card” that can be used to identify a subscriber of the mobile device 100 and to personalize the mobile device 100, among other things. Without the SIM/RUIM card 126, the mobile device 100 is not fully operational for communication with the wireless network 200. By inserting the SIM/RUIM card 126 into the SIM/RUIM interface 128, a subscriber can access all subscribed services. Services can include: web browsing and messaging such as e-mail, voice mail, Short Message Service (SMS), and Multimedia Messaging Services (MMS). More advanced services can include: point of sale, field service and sales force automation. The SIM/RUIM card 126 includes a processor and memory for storing information. Once the SIM/RUIM card 126 is inserted into the SIM/RUIM interface 128, it is coupled to the main processor 102. In order to identify the subscriber, the SIM/RUIM card 126 can include some user parameters such as an International Mobile Subscriber Identity (IMSI). An advantage of using the SIM/RUIM card 126 is that a subscriber is not necessarily bound by any single physical mobile device. The SIM/RUIM card 126 can store additional subscriber information for a mobile device as well, including datebook (or calendar) information and recent call information. Alternatively, user identification information can also be programmed into the flash memory 108.

The mobile device 100 is a battery-powered device and includes a battery interface 132 for receiving one or more rechargeable batteries 130. In at least some embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells can provide the power to the mobile device 100.

The mobile device 100 also includes an operating system 134 and software components 136 to 146 which are described in more detail below. The operating system 134 and the software components 136 to 146 that are executed by the main processor 102 are typically stored in a persistent store such as the flash memory 108, which can alternatively be a read-only memory (ROM) or similar storage element (not shown). Those skilled in the art will appreciate that portions of the operating system 134 and the software components 136 to 146, such as specific device applications, or parts thereof, can be temporarily loaded into a volatile store such as the RAM 106. Other software components can also be included, as is well known to those skilled in the art.

The subset of software applications 136 that control basic device operations, including data and voice communication applications, will normally be installed on the mobile device 100 during its manufacture. Other software applications include a message application 138 that can be any suitable software program that allows a user of the mobile device 100 to send and receive electronic messages. Various alternatives exist for the message application 138 as is well known to those skilled in the art. Messages that have been sent or received by the user are typically stored in the flash memory 108 of the mobile device 100 or some other suitable storage element in the mobile device 100. In at least some embodiments, some of the sent and received messages can be stored remotely from the device 100 such as in a data store of an associated host system that the mobile device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the mobile device 100 is turned off or loses power.

The PIM 142 includes functionality for organizing and managing data items of interest to the user, such as, but not limited to, e-mail, contacts, calendar events, voice mails, appointments, and task items. A PIM application has the ability to send and receive data items via the wireless network 200. PIM data items can be seamlessly integrated, synchronized, and updated via the wireless network 200 with the mobile device subscriber's corresponding data items stored and/or associated with a host computer system. This functionality creates a mirrored host computer on the mobile device 100 with respect to such items. This can be particularly advantageous when the host computer system is the mobile device subscriber's office computer system.

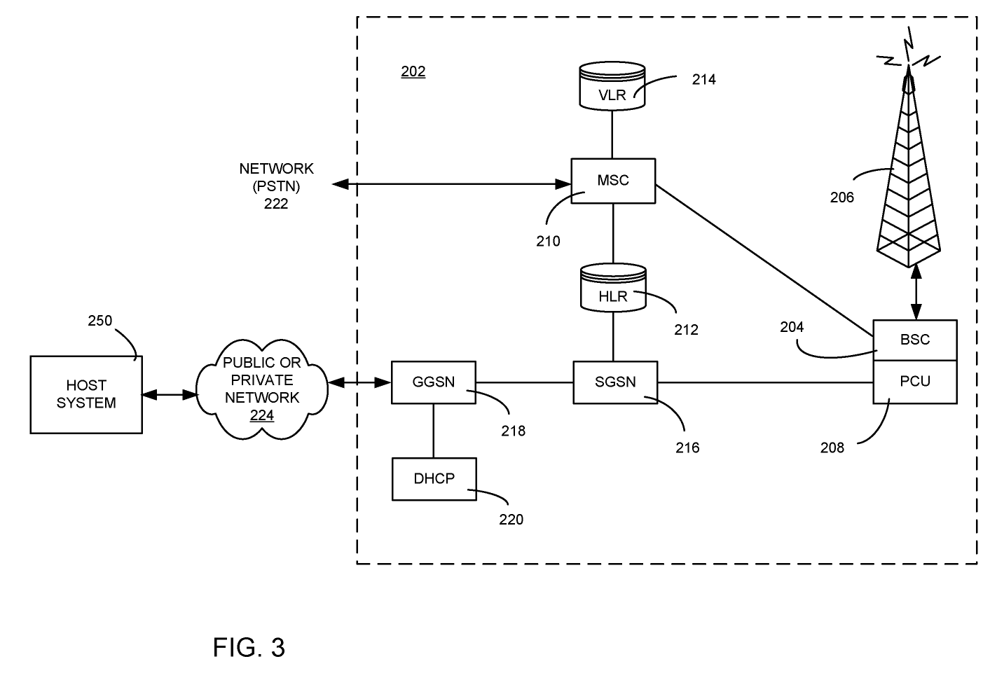

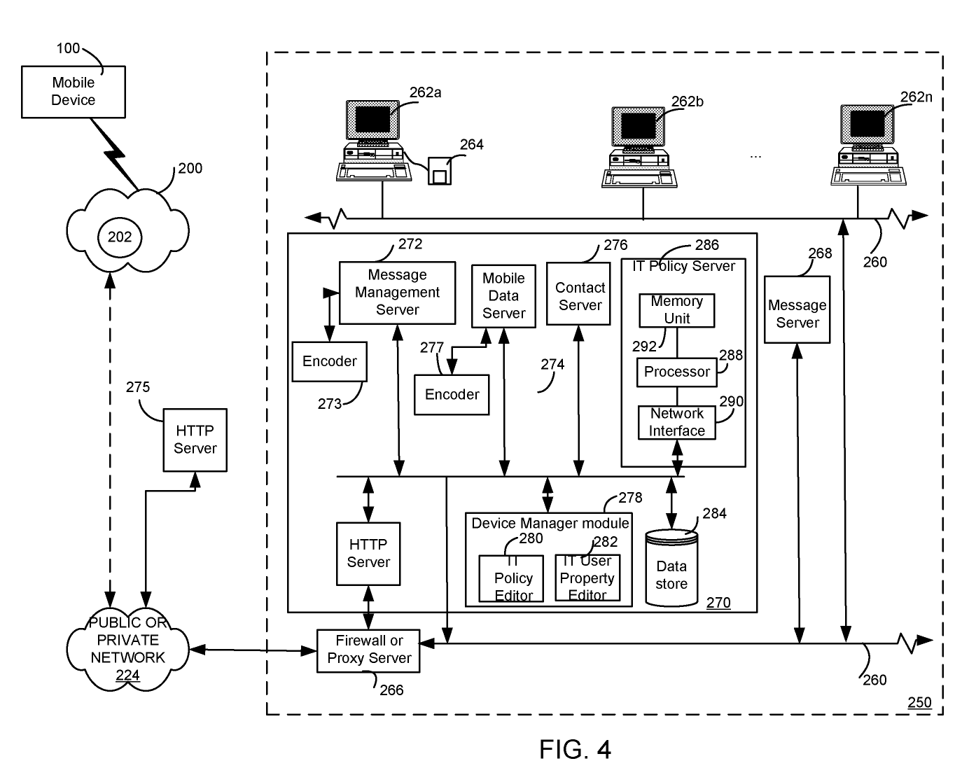

The mobile device 100 also includes a connect module 144, and an information technology (IT) policy module 146. The connect module 144 implements the communication protocols that are required for the mobile device 100 to communicate with the wireless infrastructure and any host system, such as an enterprise system, that the mobile device 100 is authorized to interface with. Examples of a wireless infrastructure and an enterprise system are given in FIGS. 3 and 4, which are described in more detail below.

The connect module 144 includes a set of Application Programming Interfaces (APIs) that can be integrated with the mobile device 100 to allow the mobile device 100 to use any number of services associated with the enterprise system. The connect module 144 allows the mobile device 100 to establish an end-to-end secure, authenticated communication pipe with the host system. A subset of applications for which access is provided by the connect module 144 can be used to pass IT policy commands from the host system to the mobile device 100. This can be done in a wireless or wired manner. These instructions can then be passed to the IT policy module 146 to modify the configuration of the device 100. Alternatively, in some cases, the IT policy update can also be done over a wired connection.

Other types of software applications can also be installed on the mobile device 100. These software applications can be third party applications, which are added after the manufacture of the mobile device 100. Examples of third party applications include games, calculators, utilities, etc.

The additional applications can be loaded onto the mobile device 100 through at least one of the wireless network 200, the auxiliary I/O subsystem 112, the data port 114, the short-range communications subsystem 122, or any other suitable device subsystem 124. This flexibility in application installation increases the functionality of the mobile device 100 and can provide enhanced on-device functions, communication-related functions, or both. For example, secure communication applications can enable electronic commerce functions and other such financial transactions to be performed using the mobile device 100.

The data port 114 enables a subscriber to set preferences through an external device or software application and extends the capabilities of the mobile device 100 by providing for information or software downloads to the mobile device 100 other than through a wireless communication network. The alternate download path can, for example, be used to load an encryption key onto the mobile device 100 through a direct and thus reliable and trusted connection to provide secure device communication.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

The short-range communications subsystem 122 provides for communication between the mobile device 100 and different systems or devices, without the use of the wireless network 200. For example, the subsystem 122 can include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 104 and input to the main processor 102. The main processor 102 will then process the received signal for output to the display 110 or alternatively to the auxiliary I/O subsystem 112. A subscriber can also compose data items, such as e-mail messages, for example, using the keyboard 116 in conjunction with the display 110 and possibly the auxiliary I/O subsystem 112. The auxiliary subsystem 112 can include devices such as: a touch screen, mouse, track ball, infrared fingerprint detector, or a roller wheel with dynamic button pressing capability. The keyboard 116 is preferably an alphanumeric keyboard and/or telephone-type keypad. However, other types of keyboards can also be used. A composed item can be transmitted over the wireless network 200 through the communication subsystem 104.

For voice communications, the overall operation of the mobile device 100 is substantially similar, except that the received signals are output to the speaker 118, and signals for transmission are generated by the microphone 120. Alternative voice or audio I/O subsystems, such as a voice message recording subsystem, can also be implemented on the mobile device 100. Although voice or audio signal output is accomplished primarily through the speaker 118, the display 110 can also be used to provide additional information such as the identity of a calling party, duration of a voice call, or other voice call related information.

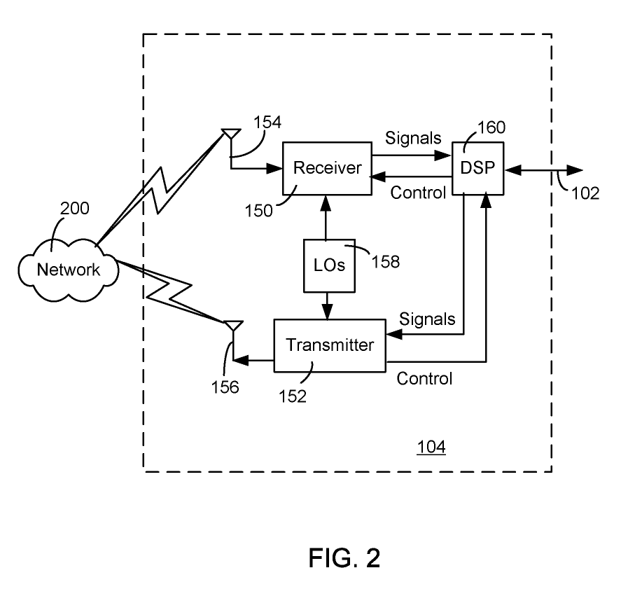

FIG. 2 shows an exemplary block diagram of the communication subsystem component 104. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160. The particular design of the communication subsystem 104 is dependent upon the communication network 200 with which the mobile device 100 is intended to operate. Thus, it should be understood that the design illustrated in FIG. 2 serves only as one example.

Signals received by the antenna 154 through the wireless network 200 are input to the receiver 150, which can perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 160. In a similar manner, signals to be transmitted are processed, including modulation and encoding, by the DSP 160. These DSP-processed signals are input to the transmitter 152 for digital-to-analog (D/A) conversion, frequency up conversion, filtering, amplification and transmission over the wireless network 200 via the antenna 156. The DSP 160 not only processes communication signals, but also provides for receiver and transmitter control. For example, the gains applied to communication signals in the receiver 150 and the transmitter 152 can be adaptively controlled through automatic gain control algorithms implemented in the DSP 160.

The wireless link between the mobile device 100 and the wireless network 200 can contain one or more different channels, typically different RF channels, and associated protocols used between the mobile device 100 and the wireless network 200. An RF channel is a limited resource that should be conserved, typically due to limits in overall bandwidth and limited battery power of the mobile device 100.

When the mobile device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

FIG. 3 is a block diagram of an exemplary implementation of a node 202 of the wireless network 200. In practice, the wireless network 200 comprises one or more nodes 202. In conjunction with the connect module 144, the mobile device 100 can communicate with the node 202 within the wireless network 200. In the exemplary implementation of FIG. 3, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable mobile devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the mobile device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from mobile devices within its cell via the station 206. The fixed transceiver equipment normally performs such functions as modulation and possibly encoding and/or encryption of signals to be transmitted to the mobile device 100 in accordance with particular, usually predetermined, communication protocols and parameters, under control of its controller. The fixed transceiver equipment similarly demodulates and possibly decodes and decrypts, if necessary, any communication signals received from the mobile device 100 within its cell. Communication protocols and parameters can vary between different nodes. For example, one node can employ a different modulation scheme and operate at different frequencies than other nodes.

For all mobile devices 100 registered with a specific network, permanent configuration data such as a user profile is stored in the HLR 212. The HLR 212 also contains location information for each registered mobile device and can be queried to determine the current location of a mobile device. The MSC 210 is responsible for a group of location areas and stores the data of the mobile devices currently in its area of responsibility in the VLR 214. Further, the VLR 214 also contains information on mobile devices that are visiting other networks. The information in the VLR 214 includes part of the permanent mobile device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each mobile device 100. The SGSN 216 also performs security functions and access control for data traffic on the wireless network 200. The GGSN 218 provides internetworking connections with external packet switched networks and connects to one or more SGSNs 216 via an Internet Protocol (IP) backbone network operated within the network 200. During normal operations, a given mobile device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a mobile device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each mobile device 100 must be assigned to one or more APNs and mobile devices 100 cannot exchange data without first performing a GPRS Attach to an APN that it has been authorized to use. The APN can be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a mobile device 100 is not using its PDP Context, the PDP Context can be de-allocated and the IP address returned to the IP address pool managed by the DHCP server 220.

FIG. 4 is a block diagram illustrating components of an exemplary configuration of a host system 250 with which the mobile device 100 can communicate in conjunction with the connect module 144. The host system 250 will typically be a corporate enterprise or other local area network (LAN), but can also be a home office computer or some other private system, for example, in variant implementations. In the example shown in FIG. 4, the host system 250 is depicted as a LAN of an organization to which a user of the mobile device 100 belongs. Typically, a plurality of mobile devices can communicate wirelessly with the host system 250 through one or more nodes 202 of the wireless network 200.

The host system 250 comprises a number of network components connected to each other by a network 260. For instance, a user's desktop computer 262a with an accompanying cradle 264 for the user's mobile device 100 is situated on a LAN connection. The cradle 264 for the mobile device 100 can be coupled to the computer 262a by a serial or a Universal Serial Bus (USB) connection, for example. Other user computers 262b-262n are also situated on the network 260, and each can be equipped with an accompanying cradle 264. The cradle 264 facilitates the loading of information (e.g. PIM data, private symmetric encryption keys to facilitate secure communications) from the user computer 262a to the mobile device 100, and can be particularly useful for bulk information updates often performed in initializing the mobile device 100 for use. The information downloaded to the mobile device 100 can include certificates used in the exchange of messages.

It will be understood by persons skilled in the art that the user computers 262a-262n are typically also connected to other peripheral devices, such as printers, etc., which are not explicitly shown in FIG. 4. Furthermore, only a subset of network components of the host system 250 are shown in FIG. 4 for ease of exposition, and it will be understood by persons skilled in the art that the host system 250 will comprise additional components that are not explicitly shown in FIG. 4 for this exemplary configuration. More generally, the host system 250 can represent a smaller part of a larger network (not shown) of the organization, and can comprise different components and/or be arranged in different topologies than that shown in the exemplary embodiment of FIG. 4.

To facilitate the operation of the mobile device 100 and the wireless communication of messages and message-related data between the mobile device 100 and components of the host system 250, a number of wireless communication support components 270 can be provided. In some implementations, the wireless communication support components 270 can include a message management server 272, a mobile data server 274, a web server, such as Hypertext Transfer Protocol (HTTP) server 275, a contact server 276, and a device manager module 278. HTTP servers can also be located outside the enterprise system, as indicated by the HTTP server 279 attached to the network 224. The device manager module 278 includes an IT Policy editor 280 and an IT user property editor 282, as well as other software components for allowing an IT administrator to configure the mobile devices 100. In an alternative embodiment, there can be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the mobile devices 100. The memory unit 292 can store functions used in implementing the IT policy as well as related data. Those skilled in the art know how to implement these various components. Other components can also be included as is well known to those skilled in the art. Further, in some implementations, the data store 284 can be part of any one of the servers.

In this exemplary embodiment, the mobile device 100 communicates with the host system 250 through node 202 of the wireless network 200 and a shared network infrastructure 224 such as a service provider network or the public Internet. Access to the host system 250 can be provided through one or more routers (not shown), and computing devices of the host system 250 can operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the mobile device 100. The wireless VPN router allows a VPN connection to be established directly through a specific wireless network to the mobile device 100. The wireless VPN router can be used with the Internet Protocol (IP) Version 6 (IPV6) and IP-based wireless networks. This protocol can provide enough IP addresses so that each mobile device has a dedicated IP address, making it possible to push information to a mobile device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the mobile device 100 in this alternative implementation.

Messages intended for a user of the mobile device 100 are initially received by a message server 268 of the host system 250. Such messages can originate from any number of sources. For instance, a message can have been sent by a sender from the computer 262b within the host system 250, from a different mobile device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly e-mail messages, within the organization and over the shared network infrastructure 224. Each user in the organization that has been set up to send and receive messages is typically associated with a user account managed by the message server 268. Some exemplary implementations of the message server 268 include a Microsoft Exchange™ server, a Lotus Domino™ server, a Novell Groupwise™ server, or another suitable mail server installed in a corporate environment. In some implementations, the host system 250 can comprise multiple message servers 268. The message server 268 can also be adapted to provide additional functions beyond message management, including the management of data associated with calendars and task lists, for example.

When messages are received by the message server 268, they are typically stored in a data store associated with the message server 268. In at least some embodiments, the data store can be a separate hardware unit, such as data store 284, with which the message server 268 communicates. Messages can be subsequently retrieved and delivered to users by accessing the message server 268. For instance, an e-mail client application operating on a user's computer 262a can request the e-mail messages associated with that user's account stored on the data store associated with the message server 268. These messages are then retrieved from the data store and stored locally on the computer 262a. The data store associated with the message server 268 can store copies of each message that is locally stored on the mobile device 100. Alternatively, the data store associated with the message server 268 can store all of the messages for the user of the mobile device 100 and only a smaller number of messages can be stored on the mobile device 100 to conserve memory. For instance, the most recent messages (i.e. those received in the past two to three months for example) can be stored on the mobile device 100.

When operating the mobile device 100, the user may wish to have e-mail messages retrieved for delivery to the mobile device 100. The message application 138 operating on the mobile device 100 can also request messages associated with the user's account from the message server 268. The message application 138 can be configured (either by the user or by an administrator, possibly in accordance with an organization's IT policy) to make this request at the direction of the user, at some pre-defined time interval, or upon the occurrence of some pre-defined event. In some implementations, the mobile device 100 is assigned its own e-mail address, and messages addressed specifically to the mobile device 100 are automatically redirected to the mobile device 100 as they are received by the message server 268.

The message management server 272 can be used to specifically provide support for the management of messages, such as e-mail messages, that are to be handled by mobile devices. Generally, while messages are still stored on the message server 268, the message management server 272 can be used to control when, if, and how messages are sent to the mobile device 100. The message management server 272 also facilitates the handling of messages composed on the mobile device 100, which are sent to the message server 268 for subsequent delivery.

For example, the message management server 272 can monitor the user's “mailbox” (e.g. the message store associated with the user's account on the message server 268) for new e-mail messages, and apply user-definable filters to new messages to determine if and how the messages are relayed to the user's mobile device 100. The message management server 272 can also, through an encoder (not shown) associated therewith, compress message data, using any suitable compression/decompression technology (e.g. YK compression, JPEG, MPEG-x, H.26×, and other known techniques) and encrypt messages (e.g. using an encryption technique such as Data Encryption Standard (DES), Triple DES, or Advanced Encryption Standard (AES)), and push them to the mobile device 100 via the shared network infrastructure 224 and the wireless network 200. The message management server 272 can also receive messages composed on the mobile device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the mobile device 100 can be defined (e.g. by an administrator in accordance with IT policy) and enforced by the message management server 272. These may include whether the mobile device 100 can receive encrypted and/or signed messages, minimum encryption key sizes, whether outgoing messages must be encrypted and/or signed, and whether copies of all secure messages sent from the mobile device 100 are to be sent to a pre-defined copy address, for example.

The message management server 272 can also be adapted to provide other control functions, such as only pushing certain message information or pre-defined portions (e.g. “blocks”) of a message stored on the message server 268 to the mobile device 100. For example, in some cases, when a message is initially retrieved by the mobile device 100 from the message server 268, the message management server 272 can push only the first part of a message to the mobile device 100, with the part being of a pre-defined size (e.g. 2 KB). The user can then request that more of the message be delivered in similar-sized blocks by the message management server 272 to the mobile device 100, possibly up to a maximum pre-defined message size. Accordingly, the message management server 272 facilitates better control over the type of data and the amount of data that is communicated to the mobile device 100, and can help to minimize potential waste of bandwidth or other resources.

The mobile data server 274 encompasses any other server that stores information that is relevant to the corporation. The mobile data server 274 can include, but is not limited to, databases, online data document repositories, customer relationship management (CRM) systems, or enterprise resource planning (ERP) applications. The mobile data server 274 can also connect to the Internet or other public network, through HTTP server 275 or other suitable web server such as an File Transfer Protocol (FTP) server, to retrieve HTTP webpages and other data. Requests for webpages are typically routed through mobile data server 274 and then to HTTP server 275, through suitable firewalls and other protective mechanisms. The web server then retrieves the webpage over the Internet, and returns it to mobile data server 274. As described above in relation to message management server 272, mobile data server 274 is typically provided, or associated, with an encoder 277 that permits retrieved data, such as retrieved webpages, to be decompressed and compressed, using any suitable compression technology (e.g. YK compression, JPEG, MPEG-x, H.26× and other known techniques), and encrypted (e.g. using an encryption technique such as DES, Triple DES, or AES), and then pushed to the mobile device 100 via the shared network infrastructure 224 and the wireless network 200. While encoder 277 is only shown for mobile data server 274, it will be appreciated that each of message server 268, message management server 272, and HTTP servers 275 and 279 can also have an encoder associated therewith.

The contact server 276 can provide information for a list of contacts for the user in a similar fashion as the address book on the mobile device 100. Accordingly, for a given contact, the contact server 276 can include the name, phone number, work address and e-mail address of the contact, among other information. The contact server 276 can also provide a global address list that contains the contact information for all of the contacts associated with the host system 250.

It will be understood by persons skilled in the art that the message management server 272, the mobile data server 274, the HTTP server 275, the contact server 276, the device manager module 278, the data store 284 and the IT policy server 286 do not need to be implemented on separate physical servers within the host system 250. For example, some or all of the functions associated with the message management server 272 can be integrated with the message server 268, or some other server in the host system 250. Alternatively, the host system 250 can comprise multiple message management servers 272, particularly in variant implementations where a large number of mobile devices need to be supported.

The device manager module 278 provides an IT administrator with a graphical user interface with which the IT administrator interacts to configure various settings for the mobile devices 100. As mentioned, the IT administrator can use IT policy rules to define behaviors of certain applications on the mobile device 100 that are permitted such as phone, web browser or Instant Messenger use. The IT policy rules can also be used to set specific values for configuration settings that an organization requires on the mobile devices 100 such as auto signature text, WLAN/VoIP/VPN configuration, security requirements (e.g. encryption algorithms, password rules, etc.), specifying themes or applications that are allowed to run on the mobile device 100, and the like.

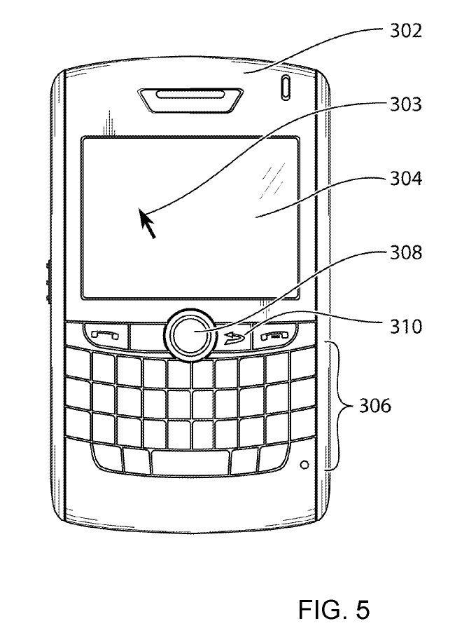

Rendering data files originally optimized or prepared for visualization on large-screen displays on a portable electronic device display often requires additional processing prior to visualization on the small-screen portable electronic device displays. According to an embodiment, this additional processing is accomplished by the rendering engine 125 shown in FIG. 1. As will be appreciated by those of skill in the art, the rendering engine can be implemented in hardware, software, or a combination thereof, and can comprise a dedicated image processor and associated circuitry, or can be implemented within main processor 102. FIG. 5 shows a mobile device 300 that can render and display data files in at least one of two different display modes or views. The data files can be of any type, such as a webpage, text document, spreadsheet, email message or image file. The mobile device 300 may be a dual mode (simultaneous data and voice communication capabilities), such as the device 100 described above, or a single mode communication device, personal digital assistant, or other portable electronic device having a display. The device 300 may be able to display data files in different display modes or views, such as a layout view or a column view. The layout view displays the file as formatted for desktop display or printing, maintaining the order, formatting and spatial relationships between elements, components and segments of the data file as determined by formatting and layout instructions included or associated with the data file. The column view displays the text or image data in a continuous, scrollable column, and may remove, adapt, modify or transform elements, segments or components that cannot be displayed in a text format, or other format suitable for column display. The size and magnification of the displayed data file can be controlled by a zooming function supported by the mobile device 300. The terms “zoom” and “zooming” are used throughout this description to refer to increasing and decreasing the size and magnification of a data file displayed in a page layout view, where “zooming-in” refers to increasing the size and magnification, and “zooming-out” refers to decreasing the size and magnification.

Formatting and layout of the components and segments of the data file can be, for example, specified by markup language tags, such as HyperText Markup Language (HTML) or eXtensible Markup Language (XML), or by proprietary formatting and layout codes. The components or segments of a data file can also include data, such as text or image data, and can include selectable or editable form fields, such as hyperlinks, radio buttons, drop-down or pop-up menus, and data entry fields.

Generally, according to an embodiment, the present method comprises rendering a data file on a portable device display of a mobile communications device. The data file is rendered on the portable device display in one of a layout view that causes the data file, or a page thereof, to be displayed in accordance with formatting and layout instructions associated with the data file, and a column view that causes elements of the data file to be modified and displayed in a substantially continuous column format. A portion of the data file is identified based on a position of a cursor within the one of the display view and the column view, and when actuation of a trackball in a first actuation mode is detected, the data file is rendered in the other of the layout view or the column view within the identified portion. According to a further embodiment, a mobile communications device for implementing the method is provided having a portable device display and a trackball.

The device 300 includes a portable housing 302, a display 304 and input keys 306. The device 300 also includes one or more input devices, implements or means, such as a touchscreen, touchpad, or the illustrated trackball 308, that permits a user to navigate or scroll through menus and files visualized on the display 304, and to control a cursor 303 displayed on the display 304. While the remainder of this description refers to trackball 308, such references should be considered non-limiting, and any input device that permits a user to navigate or scroll through files and screens displayed on display 304, or to otherwise invoke functions by manual interaction, is fully within the contemplation of the present device and method. The input device preferably permits the cursor 303, or other displaceable screen icon or element, to be positioned anywhere within the viewable screen of the display 304. The input device is also preferably controlled and actuated by a user's single digit, though some functions may require multi-digit actuation, or may require a combined actuation of the input device and another input means, such as one of input keys 306. The trackball 308 is preferably “clickable”, such that desired functions, options, menus or selections can be made by clicking the trackball. An “escape” or “back” function input means, such as escape key 310, here shown directly adjacent the trackball 308, permits a user to return to a previous screen or display. The escape or back function can be invoked in any suitable manner, as is well known to those of skill in the art. For example, the escape function can be invoked by a context-dependent interaction with a touchscreen or touchpad, actuation of a button on the side of the portable device housing 302, or a single or combined user input from any other input devices, implements or means. The input keys 306 are used to enter text to create or modify a file, the input text typically being visualized on the display 304. The device 300 also includes a transceiver (not shown) for receiving and transmitting data files, a battery (not shown) to supply power to internal circuitry and the display 304, and to generate electrical signals in response to operation of the input keys 306, the trackball 308, the escape key 310, and the transceiver.

According to an embodiment, the dimensions and displayed area or portion of a data file displayed on the portable device display 304 can be controlled to provide zoom functionality with single digit control. The method first comprises displaying the data file on the portable device display 304 in a full layout view. A cursor is displayed in the layout view as a zoom icon, such as a magnifying glass cursor, with which any portion of the layout view can be selected by positioning the zoom icon, and triggering or invoking an associated zoom tool by actuating an input device, implement or means, such as trackball 308. In response to actuation of the trackball 308, the selected portion is displayed in the portable device display at a next higher size. The process can be repeated to successively zoom in on a desired portion of the data file, until a maximum magnification level is reached. As noted above in relation to FIG. 1, the device 300 includes a processor and rendering circuit to control the display 304. The processor, rendering circuit and appropriate software applications, such as the zoom tool, interact to display a data file in the full layout view or the column view, cause the cursor to display as a zoom icon in the layout view, and render selected portions of the data file at higher or lower displayed sizes.

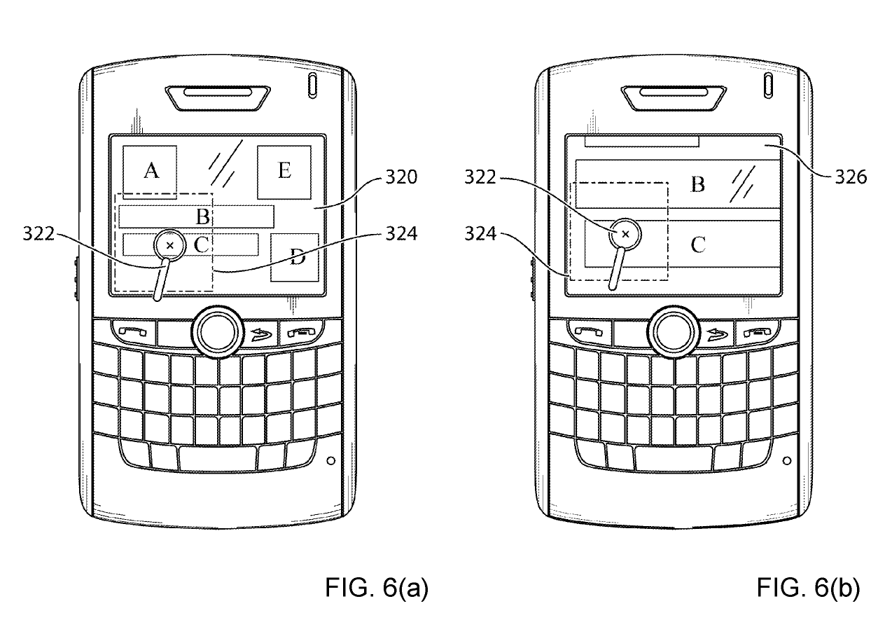

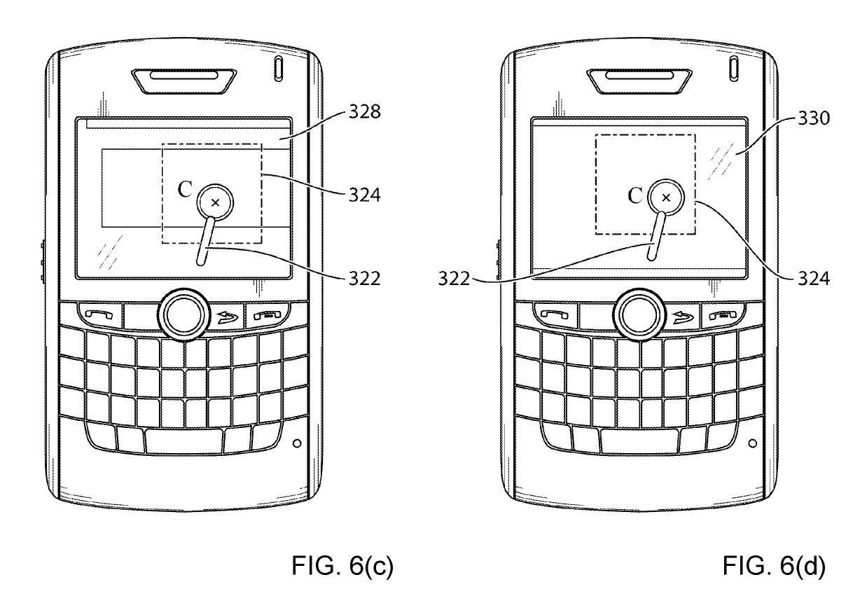

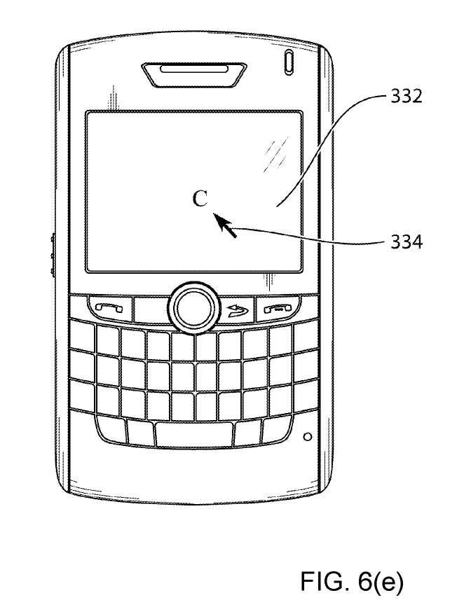

An example of the zoom functionality is illustrated in the sequence of FIGS. 6(a)-6(e). FIG. 6(a) shows a data file displayed in a full layout view 320 within the display 304. A layout view is a view that displays a data file with formatting and spatial relationships between components, segments and elements as specified by the formatting and layout codes provided with the file. The full layout view displays the full data file, or page thereof, whereas subsequent layout views may only show a portion of the data file or page, however, in both the full layout view and the partial layout views, the formatting and spatial relationships are maintained. The full layout view 320 is the view that would, for example, be displayed to a user in a browser in a conventional desktop environment, or in a print preview or print layout mode in a desktop publishing application. The exemplary full layout view 320 includes a number of components or segments A, B, C, D and E. These components or segments can be, for example, separate frames, text files, image files, tables, charts, banners, etc. A component or segment can include data that can be extracted and displayed in an unformatted, or reduced format. When a data file is displayed in the full layout view, the cursor 322 is, for example, displayed as a magnifying glass, or other zoom icon, that indicates to the user that zoom functionality is available.

Zooming within the data file is accomplished by positioning the cursor 322 within a portion of the layout view 320 that the user desires to see at a higher magnification. In the illustrated example, the cursor 322 is positioned over component C. The positioning of the cursor 322 is, for example, achieved by the user scrolling or rolling the trackball 308. The hashed rectangle 324 surrounding the cursor 322 indicates the portion of the layout view 322 that will be displayed at the next higher magnification. Rectangle 324 is shown for illustrative purposes only, and would not, in most embodiments, be visible to the user. Rectangle 324 has generally the same aspect ratio as the display 304. Once the cursor 322 has been appropriately positioned within the full layout view 320, the user actuates, or clicks, the trackball 308 to invoke or trigger the zoom tool installed on the device. The rendering circuit 125 (see FIG. 1), then renders the portion of the full layout view 320 contained within rectangle 324 and displays the selected portion on the display 304, as shown by the magnified layout view 326 shown in FIG. 6(b), centering the display at the point where the cursor was placed in the previous layout view.

As shown in FIGS. 6(b)-6(e), the user continues to zoom in on component C, by positioning the cursor 322 within component C and clicking the trackball 308, until a highest supported display size is reached. In the illustrated example, five layout view magnification levels are shown, beginning at the full layout view 320 and progressing through magnified layout views 326, 328, 330, and 332. To indicate to the user that the highest-supported magnified layout view 332 (i.e., the view having the greatest magnification supported by the application) has been reached, the cursor 322 can, for example, change from the magnifying glass to a different form, such as the illustrated arrow 334.

According to an embodiment of the readability control method, the rendering and display of a data file on the display 304 can be switched between a layout view and a column view. Initially, the data file is displayed on the display 304 in one of the layout view or the column view. A portion of the displayed data file is selected by positioning a cursor over the portion and a trackball is actuated, for example, by clicking and holding the trackball for a predetermined time to display the data file in the other of the layout view or the column view within the selected portion. The selected portion is rendered on the display and centered generally in the vicinity of the cursor position when actuating the trackball.

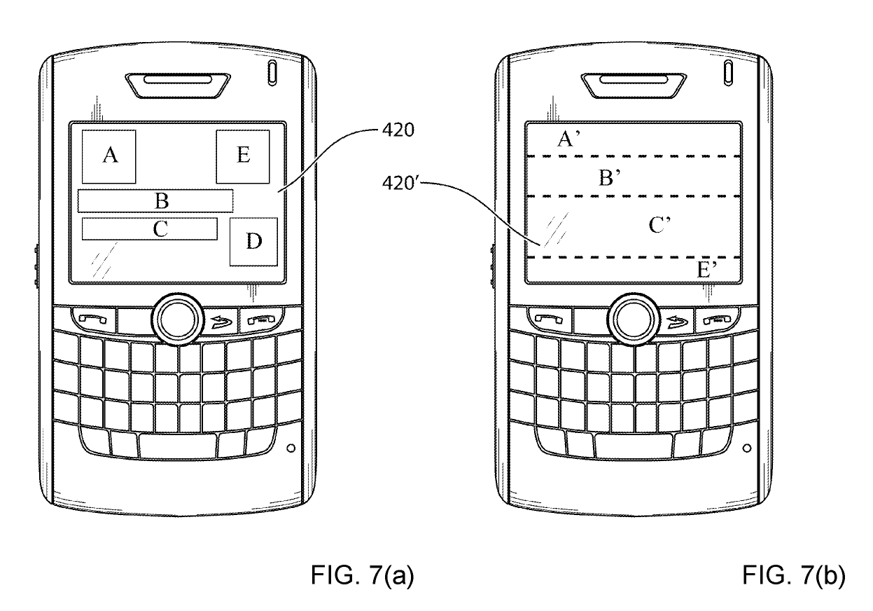

An example of the readability control is illustrated in FIGS. 7(a) and 7(b). FIG. 7(a) is similar to FIG. 6(a) and shows a data file displayed in a full layout view 420 within the display 304. The full layout view 420 includes a number of components or segments A, B, C, D and E. In order to improve readability of the displayed data file, the user can switch, or toggle, between the full layout view to the column view 420′. Switching from the full layout view 420 to the column view 420′ is accomplished by actuating the trackball 308, such as, in a first actuating mode, for example, by clicking and holding the trackball 308 for a predetermined time (e.g., 500 milliseconds).

As shown in FIG. 7(a), in the layout view 420, the spatial relationships and formatting of components or segments of the data file are preserved thereby providing a familiar visual appeal that is associated with the particular data file. On the other hand, as shown in FIG. 7(b), displaying the data file in the column view 420′ alters, adapts, transforms or modifies the components of the data file for viewing on the portable device display 304 for display as a substantially continuous column. Spatial relationships and/or formatting of the components or segments may be altered, deleted, or otherwise modified. The column view 420′ displays the text or image data in a continuous, scrollable column. For example, as shown in FIG. 7(b) components or segments A′, B′, C′, and E′ are displayed in a columnar manner. In the example shown, the component D cannot be displayed in a text format and has been removed by the rendering circuit 125 (see FIG. 1).

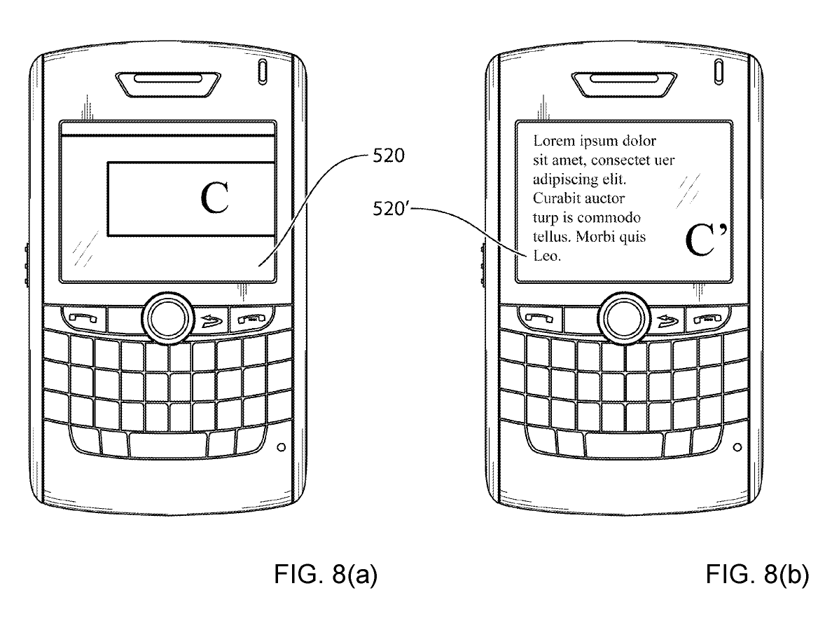

FIGS. 8(a) and 8(b) provide yet another example of the readability control obtained by switching between layout view and column view. In this example, the user has zoomed in on component C as described earlier. The user can switch from the layout view 520 shown in FIG. 8(a) to a column view 520′ shown in FIG. 8(b). The component C has been transformed into a single column text format and rendered as column view 520′ by the rendering circuit 125.

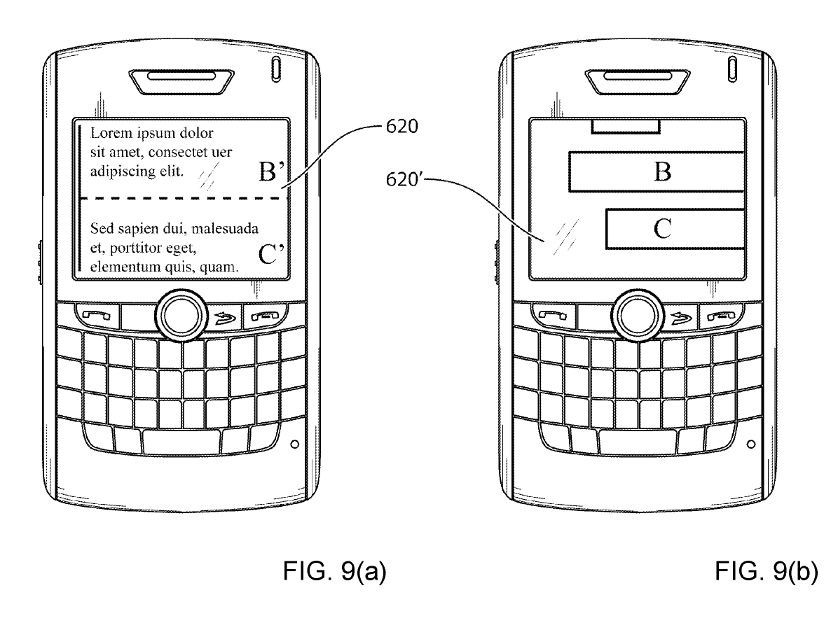

The user can also switch from the column view to the layout view as illustrated in FIGS. 9(a) and 9(b). As shown in FIG. 9(a), components B′ and C′ are rendered in a single column text format in column view 620′. By clicking and holding the trackball 308 for a predetermined time as above, or otherwise actuating the trackball 308 in a first actuation mode, the user can switch from the column view 620′ to the layout view 620, as shown in FIG. 9(b). Typically, the layout view is rendered on the display centered generally in the vicinity of the cursor position when actuating the trackball.

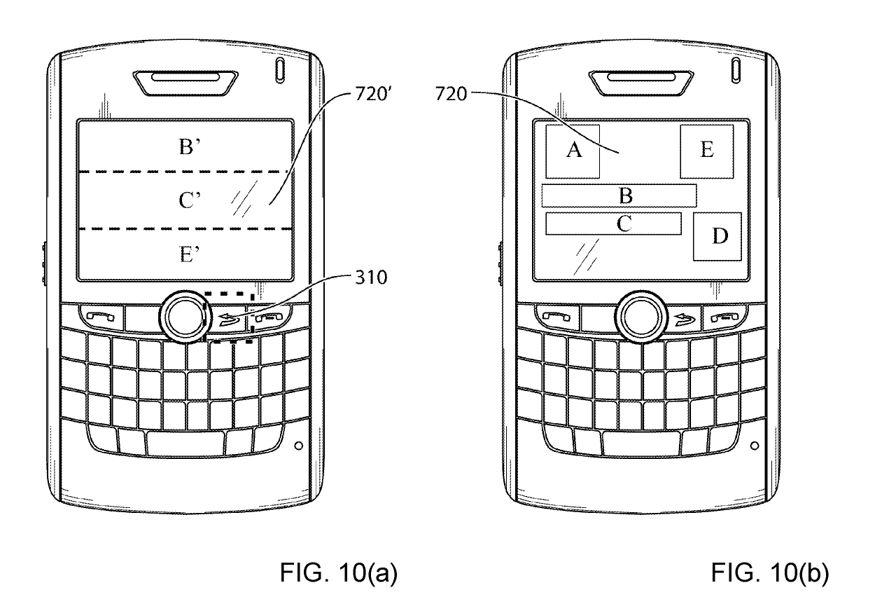

The user can, at any time, actuate the escape key 310 when in the column view to return to the full layout view as shown in FIG. 6(a). In the example shown in FIG. 10(a), components B′, C′ and E′ are rendered in column view 720′. The user can actuate the escape key 310 to switch directly to the full layout view 720 as shown in FIG. 10(b). The actuation of the escape key 310 provides a single step transition from a column view to the full layout view.

According to another embodiment of the readability control method, a selected portion of a data file displayed on a portable device display 304 in a layout view can be controlled by the actuation of the trackball 308 in a first or second mode of actuation. According to a first exemplary mode of actuation of the trackball, as described above, a user clicks and holds the trackball 308 for a predetermined time, causing the display of the selected portion to switch from the layout view to a column view. In the second mode of actuation of the trackball, for example, simply clicking the trackball 308, causes the selected portion to be displayed at a higher magnification as described above in relation to FIGS. 6(a) to 6(e).

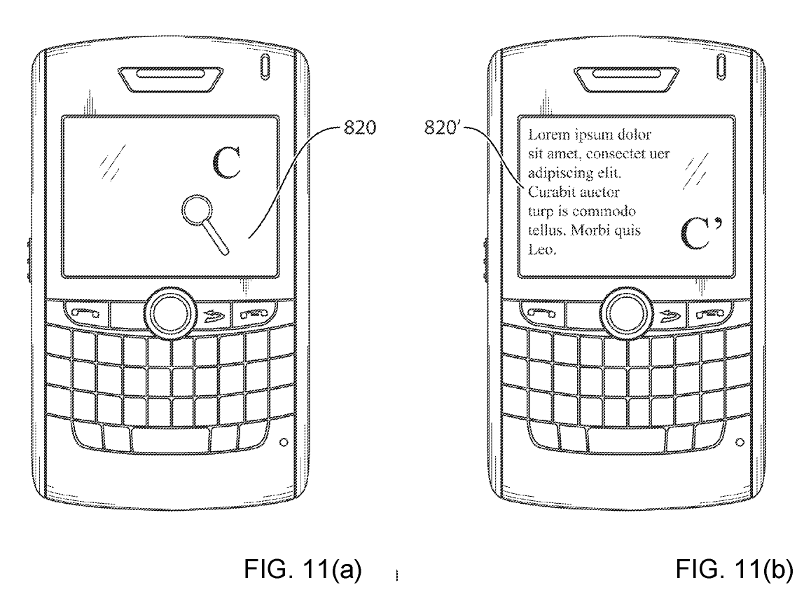

FIGS. 11(a) and 11(b) show a further embodiment in which the column view is automatically entered upon actuation of the trackball 308 in the second actuation mode. FIG. 11(a) shows component C at the highest supported magnification in the layout view 820. Actuating the trackball 308, for example, by clicking the trackball, will result in the layout view 820 switched to the column view 820′ of FIG. 11(b). In the column view 820′, the component C′ is rendered in a single column text format. Rather than requiring the user to click and hold, the switch to column view is accomplished by simply clicking the trackball 308 (i.e., the second mode actuation). In this embodiment, the switch to column view can be seen as a further magnification or display level of the layout view.

In the embodiments described above, the cursor can be dynamically modified in accordance with its position in relation to certain elements of the displayed data file. For example, the cursor 322 can change to a selection icon, such as the illustrated “hand” icon, when moved over an element, such as a form field, that can be selected, filled, or otherwise launched, such as a checkbox or a radio button. The function executed in response to actuating the trackball, or other input device, will depend on the state of the cursor. When the cursor is displayed as a zoom icon (e.g. magnifying glass), zooming functions, as described above, can be invoked or triggered by the zoom tool installed on the device. When the cursor is displayed as a selection icon (e.g. a “hand” icon) and the underlying selection tool is triggered, such as by receiving an indication that the input device has been actuated, an action appropriate to the form field can be invoked. As is known in the art, a form field is a data-entry field on a page. A user supplies information in the form field either by typing text or by selecting the field. Examples of form fields include text fields, password fields, radio buttons, check boxes, drop down lists, hyperlinks, submit buttons, reset buttons and other buttons. For example, selecting a radio button can cause an item to be selected in a list, selecting a hyperlink can result in display of a new page, and selecting a menu can result in a drop-down or pop-up menu being displayed. The cursor can also dynamically change to an “I” insert cursor when moved over an editable element, such as a data entry field. According to a further embodiment, the dynamic switch from a zoom icon to a selection or input icon only occurs if the cursor remains over the form field for a predetermined amount of time, such as 300 milliseconds. Similarly, according to yet another embodiment, the zoom icon can be dynamically modified to a selection icon as it is positioned over a form field, and, if the no action is taken by the user to actuate the element within a predetermined time, the cursor can automatically revert to the zoom icon.

In another embodiment, at the widest view (i.e. the full layout view or the level with the lowest magnification), or other magnified views at which individual form fields of the page are considered to be too small to interact with at that particular magnification, the cursor can be limited to the zoom icon, such as the magnifying glass cursor, rather than dynamically changing to a selection icon when passed over a form field. The determination that individual form fields are too small to interact with at a given magnification can be based on dimensions of each such field at the displayed magnification. In other words, the zoom icon would only switch to the selection icon when positioned over form fields having at least one dimension that is greater than a certain number of pixels (i.e., only when passed over relatively “large” items in the page). In a further embodiment, the cursor can be locked to the zoom icon configuration if any form field on the displayed page has at least one dimension that is less than a predetermined number of pixels when rendered at the given magnification. According to other embodiments dynamic cursor modification is only activated for particular magnifications, such as only the most magnified layout view.

According another embodiment, when dynamic modification of the cursor is implemented, switching from layout to column view can still be invoked by the first mode of actuation (i.e. a click-and-hold actuation), regardless of whether the cursor is positioned over a form field or not. According to this embodiment, a simple click actuation would invoke the function associated with the form field, such as a hyperlink, while a click-and-hold operation would cause a transition to the column view.

As will be appreciated by those of skill in the art, the method and apparatus described herein permits a user to toggle image display from a layout view to a column view in a single-handed manner using a trackball. The cursor dynamically changes in response to the display mode and the position of the cursor in relation to particular elements, components or segments of the displayed data file.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method of rendering a data file on a portable device display of a mobile communication device, comprising:
rendering the data file on the portable device display in one of a layout view that causes the data file, or a page thereof, to be displayed in accordance with formatting and layout instructions associated with the data file, and a column view that causes elements of the data file to be modified and displayed in a substantially continuous column format;
identifying a portion of the data file based on a position of a cursor within the one of the display view and the column view;
detecting actuation of a trackball in a first actuation mode; and
in response to the actuation of the trackball in the first actuation mode, causing the data file to be rendered in the other of the layout view or the column view within the identified portion.

2. The method of claim 1, wherein the first actuation mode is a click-and-hold mode.

3. The method of claim 1, further comprising causing the data file to be rendered in the other of the layout view or the column view with the identified portion being centered generally in the vicinity of the cursor position when actuation of the trackball is detected.

4. The method of claim 1, further comprising:
detecting the cursor to be positioned over a form field; and
dynamically modifying the cursor to be displayed as an icon indicative of a selection tool.

5. The method of claim 4, further comprising:
detecting a triggering of the selection tool in response to actuation of the input device on the mobile communication device; and
in response to the triggering of the selection tool, causing a function of the form field to be invoked.

6. The method of claim 4, wherein the form field is a hyperlink.

7. The method of claim 4, wherein the form field is one of a radio button, a check box, a drop down list, a submit button, or a reset button.

8. The method of claim 1, further comprising:
detecting the cursor to be positioned over an editable form field; and
dynamically modifying the cursor to be displayed as an icon indicative of an edit tool.

9. The method of claim 8, wherein the editable form field is a text field, or a password field.

10. The method of claim 1, further comprising:
detecting a triggering of an escape function when the data file is rendered in the column view; and
in response to the triggering of the escape function, causing the data file to be rendered in the full layout view.

11. The method of claim 1, further comprising:
detecting actuation of the trackball in a second actuation mode; and
in response to detecting actuation of the trackball in the second actuation mode, causing the identified portion of the one of the layout view and the column view to be rendered on the portable device display in a magnified view.

12. The method of claim 11, wherein, when the one of the layout view and the column view is a layout view at a highest supported magnification level, the magnified view is the column view.

13. The method of claim 11, wherein the second actuation mode is a click mode.

14. A portable electronic device comprising:
a display mounted within a portable device housing;
an input device for positioning a cursor on the display and for triggering an action, the input device mounted on the portable housing;
a processor configured to control the display to render a data file on the display in one of a layout view that causes the data file, or a page thereof, to be displayed in accordance with formatting and layout instructions associated with the data file, and a column view that causes elements of the data file to be modified and displayed in a substantially continuous column format, to identify a portion of the data file based on a position of the cursor within the one of the display view and the column view, to detect actuation of the trackball in a first actuation mode, and in response to the actuation of the trackball in the first actuation mode, to cause the data file to be rendered in the other of the layout view or the column view within the identified portion.

15. The portable electronic device of claim 14, wherein the first actuation mode is a click-and-hold mode.

16. The portable electronic device of claim 14, wherein the processor is further configured to cause the data file to be rendered in the other of the layout view or the column view with the identified portion being centered generally in the vicinity of the cursor position when actuation of the trackball is detected.

17. The portable electronic device of claim 14, wherein the processor is further configured to:
detect the cursor to be positioned over a form field; and
dynamically modify the cursor to be displayed as an icon indicative of a selection tool.

18. The portable electronic device of claim 17, wherein the processor is further configured to:
detect a triggering of the selection tool in response to actuation of the input device on the mobile communications device; and
in response to the triggering of the selection tool, cause a function of the form field to be invoked.

19. The portable electronic device of claim 17, wherein the form field is a hyperlink.

20. The portable electronic device of claim 17, wherein the form field is one of a radio button, a check box, a drop down list, a submit button, or a reset button.

21. The portable electronic device of claim 14, wherein the processor is further configured to:
detect the cursor to be positioned over an editable form field; and
dynamically modify the cursor to be displayed as an icon indicative of an edit tool.

22. The portable electronic device of claim 21, wherein the editable form field is a text field, or a password field.

23. The portable electronic device of claim 14, wherein the processor is further configured to:
detect a triggering of an escape function when the data file is rendered in the column view; and
in response to the triggering of the escape function, cause the data file to be rendered in the full layout view.

24. The portable electronic device of claim 14, wherein the processor is further configured to:
detect actuation of the trackball in a second actuation mode; and
in response to detecting actuation of the trackball in the second actuation mode, cause the identified portion of the one of the layout view and the column view to be rendered on the portable device display in a magnified view.

25. The portable electronic device of claim 24, wherein, when the one of the layout view and the column view is a layout view at a highest supported magnification level, the magnified view is the column view.

26. The portable electronic device of claim 24, wherein the second actuation mode is a click mode.
